(19) United States
(12) Patent Application Publication
(10) Pub. No.: US 2025/0265062 A1
(43) Pub. Date: Aug. 21, 2025

(54) SYSTEM AND METHOD FOR GENERATING DEPLOYABLE COMPONENTS ASSOCIATED WITH SOFTWARE APPLICATIONS FOR INCOMING REQUESTS VIA AN ADAPTIVE ZERO-TRUST GENERATIVE ARTIFICIAL INTELLIGENCE ENGINE

(71) Applicant: BANK OF AMERICA CORPORATION, Charlotte, NC (US)

(72) Inventors: Anurajam Rajagopalan, Chennai (IN); Subburathinam Krishnan, Chennai (IN); Kiran Pulla, Hyderabad (IN); Anantharajan Srinivasarangan, Chennai (IN)

(73) Assignee: BANK OF AMERICA CORPORATION, Charlotte, NC (US)

(21) Appl. No.: 18/583,274

(22) Filed: Feb. 21, 2024

(51) Int. Cl. G06F 8/61

(52) U.S. Cl. CPC G06F 8/61

(57) ABSTRACT

Embodiments of the present invention provide a system for generating deployable components associated with software applications for incoming requests via an adaptive zero-trust generative artificial intelligence engine. The system is configured for monitoring one or more requests entering an entity network associated with an entity, filtering the one or more requests based on one or more dynamically changing filters, determining intent associated with the one or more requests based on filtering the one or more requests, generating multiple solutions to achieve the intent associated with the one or more requests, identifying an optimized solution from the multiple solutions via a cross validation decision tree, generating a deployable component associated with the optimized solution, and executing the deployable component via a channel.

### BACKGROUND

There exists a need for a system for generating deployable components associated with software applications for incoming requests via an adaptive zero-trust generative artificial intelligence engine.

### BRIEF SUMMARY

Embodiments of the present invention address the above needs and/or achieve other advantages by providing apparatuses (e.g., a system, computer program product and/or other devices) and methods for generating deployable components associated with software applications for incoming requests via an adaptive zero-trust generative artificial intelligence engine. The system embodiments may comprise one or more memory devices having computer readable program code stored thereon, a communication device, and one or more processing devices operatively coupled to the one or more memory devices, wherein the one or more processing devices are configured to execute the computer readable program code to carry out the invention. In computer program product embodiments of the invention, the computer program product comprises at least one non-transitory computer readable medium comprising computer readable instructions for carrying out the invention. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the invention.

In some embodiments, the present invention monitors one or more requests entering an entity network associated with an entity, filters the one or more requests based on one or more dynamically changing filters, determines intent associated with the one or more requests based on filtering the one or more requests, generates multiple solutions to achieve the intent associated with the one or more requests, identifies an optimized solution from the multiple solutions via a cross validation decision tree, generates a deployable component associated with the optimized solution, and executes the deployable component via a channel.

In some embodiments, the present invention determines one or more channels for executing the deployable component and selects the channel of the one or more channels for executing the deployable component based on the intent associated with the one or more requests.

In some embodiments, filtering the one or more requests comprises categorizing the one or more requests based on the one or more dynamically changing filters.

In some embodiments, the present invention generates the dynamically changing filters based on historical request processing data.

In some embodiments, the present invention updates the dynamically changing filters based on outcomes associated with executing the deployable component.

In some embodiments, the present invention identifies the optimized solution from the multiple solutions via the cross validation decision tree based on performing impact analysis on the multiple solutions.

In some embodiments, the present invention generates a unique identifier for the one or more requests and links the unique identifier to the one or more requests to allow tracking processing associated with the one or more requests.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 provides a block diagram illustrating a system environment for generating deployable components associated with software applications for incoming requests via an adaptive zero-trust generative artificial intelligence engine, in accordance with an embodiment of the invention;

FIG. 2 provides a block diagram illustrating the entity system 200 of FIG. 1, in accordance with an embodiment of the invention;

FIG. 3 provides a block diagram illustrating a deployable component generation system 300 of FIG. 1, in accordance with an embodiment of the invention;

FIG. 4 provides a block diagram illustrating the computing device system 400 of FIG. 1, in accordance with an embodiment of the invention;

FIGS. 5 provides a process flow for generating deployable components associated with software applications for incoming requests via an adaptive zero-trust generative artificial intelligence engine, in accordance with an embodiment of the invention; and

FIG. 6 provides a block diagram illustrating the process of generating deployable components associated with software applications for incoming requests via an adaptive zero-trust generative artificial intelligence engine, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As described herein, the term “entity” may be any organization that creates, manages, develops, provides, and/or uses one or more applications (e.g., web applications, mobile applications, or the like) to perform one or more activities. In some embodiments, the entity may be a financial institution which may include any financial institutions such as commercial banks, thrifts, federal and state savings banks, savings and loan associations, credit unions, investment companies, insurance companies and the like. In some embodiments, the entity may be a non-financial institution.

Many of the example embodiments and implementations described herein contemplate interactions engaged in by a user with a computing device and/or one or more communication devices and/or secondary communication devices. A “user”, as referenced herein, may refer to an entity or individual that has the ability and/or authorization to access and use one or more applications, systems, servers, and/or devices provided by the entity and/or the system of the present invention. Furthermore, as used herein, the term “user computing device” or “mobile device” may refer to mobile phones, computing devices, tablet computers, wearable devices, smart devices and/or any portable electronic device capable of receiving and/or storing data therein.

A “user interface” is any device or software that allows a user to input information, such as commands or data, into a device, or that allows the device to output information to the user. For example, the user interface includes a graphical user interface (GUI) or an interface to input computer-executable instructions that direct a processing device to carry out specific functions. The user interface typically employs certain input and output devices to input data received from a user or to output data to a user. These input and output devices may include a display, mouse, keyboard, button, touchpad, touch screen, microphone, speaker, LED, light, joystick, switch, buzzer, bell, and/or other user input/output device for communicating with one or more users.

Typically, an entity may develop, utilize, maintain, and/or manage ‘n’ number of applications, where each of the applications may be configured for performing one or more entity operations. Such entity applications are developed over a long span of time, where multiple entity users (e.g., application developers) may use multiple coding standards, programming languages, frameworks, or the like to develop the entity applications. When entity applications are developed in such a way, understanding and knowledge associated with each of the entity applications will eventually decrease as time progresses. When a request is initiated to add, modify, and/or delete functionalities to the entity applications that were developed a long time ago, lack of knowledge regarding the entity applications may increase the probability of improperly fulfilling the request, thereby causing failure of functionalities, downtime of applications, or the like. Additionally, such entity applications may also be vulnerable to malicious activities that may include advanced attempts to cause data breaches, malware attacks, and/or the like and resolving and safeguarding against such attempts may be a time consuming process specifically when knowledge associated with the entity applications is sparse. As such, there exists a need for a system that overcomes these technical problems and provides a solution for generating instantaneous resolutions for such problems related to entity applications.

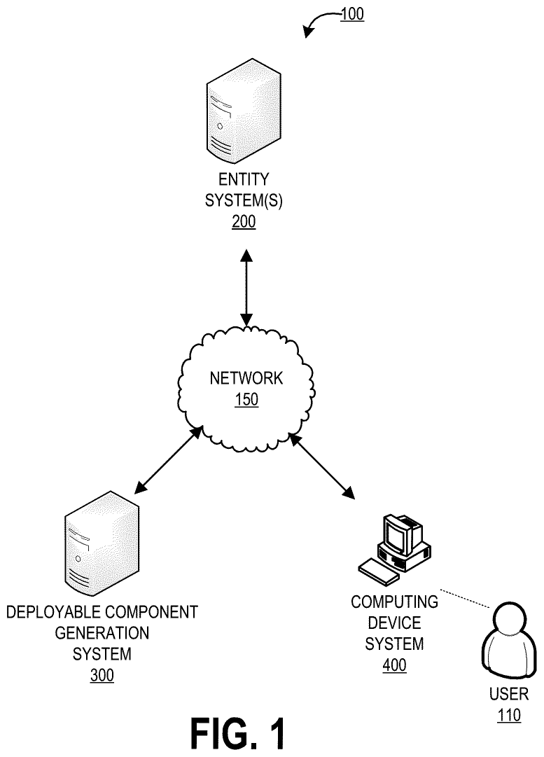

FIG. 1 provides a block diagram illustrating a system environment 100 for generating deployable components associated with software applications for incoming requests via an adaptive zero-trust generative artificial intelligence engine, in accordance with an embodiment of the invention. As illustrated in FIG. 1, the environment 100 includes a deployable component generation system 300, entity system 200, and a computing device system 400. One or more users 110 may be included in the system environment 100, where the users 110 interact with the other entities of the system environment 100 via a user interface of the computing device system 400. In some embodiments, the one or more user(s) 110 of the system environment 100 may be employees of an entity associated with the entity system 200 (e.g., software engineer, application developer, application tester, and/or the like). In some embodiments, the one or more user(s) 110 of the system environment 100 may be customers of the entity associated with the entity system 200. In some embodiments, the one or more user(s) 110 of the system environment 100 may be potential customers of the entity associated with the entity system 200.

The entity system(s) 200 may be any system owned or otherwise controlled by an entity to support or perform one or more process steps described herein. In some embodiments, the entity is a financial institution. In some embodiments, the entity is a non-financial institution.

The deployable component generation system 300 is a system of the present invention for performing one or more process steps described herein. In some embodiments, the deployable component generation system 300 may be an independent system. In some embodiments, the deployable component generation system 300 may be a part of the entity system 200.

The deployable component generation system 300, the entity system 200, and/or the computing device system 400 may be in network communication across the system environment 100 through the network 150. The network 150 may include a local area network (LAN), a wide area network (WAN), and/or a global area network (GAN). The network 150 may provide for wireline, wireless, or a combination of wireline and wireless communication between devices in the network. In one embodiment, the network 150 includes the Internet. In general, the deployable component generation system 300 is configured to communicate information or instructions with the entity system 200, and/or the computing device system 400 across the network 150.

The computing device system 400 may be a computing device of the user 110. In general, the computing device system 400 communicates with the user 110 via a user interface of the computing device system 400, and in turn is configured to communicate information or instructions with the deployable component generation system 300 and/or entity system 200 across the network 150.

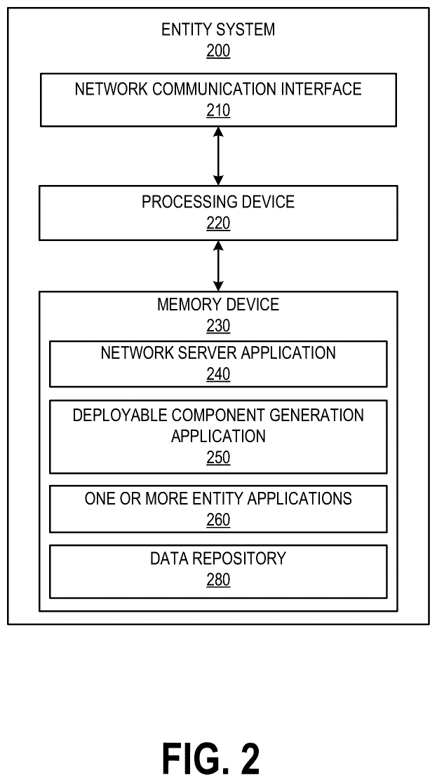

FIG. 2 provides a block diagram illustrating the entity system 200, in greater detail, in accordance with embodiments of the invention. As illustrated in FIG. 2, in one embodiment of the invention, the entity system 200 includes one or more processing devices 220 operatively coupled to a network communication interface 210 and a memory device 230. In certain embodiments, the entity system 200 is operated by an entity, such as a financial institution, while in other embodiments, the entity system 200 is operated by an entity other than a financial institution.

It should be understood that the memory device 230 may include one or more databases or other data structures/repositories. The memory device 230 also includes computer-executable program code that instructs the processing device 220 to operate the network communication interface 210 to perform certain communication functions of the entity system 200 described herein. For example, in one embodiment of the entity system 200, the memory device 230 includes, but is not limited to, a network server application 240, a deployable component generation application 250, one or more entity applications 260, and a data repository 280. The computer-executable program code of the network server application 240, the deployable component generation application 250, and the one or more entity applications 260 to perform certain logic, data-extraction, and data-storing functions of the entity system 200 described herein, as well as communication functions of the entity system 200.

The network server application 240, the deployable component generation application 250, and the one or more entity applications 260 are configured to store data in the data repository 280 or to use the data stored in the data repository 280 when communicating through the network communication interface 210 with the deployable component generation system 300, and the computing device system 400 to perform one or more process steps described herein. In some embodiments, the entity system 200 may receive instructions from the deployable component generation system 300 via the deployable component generation application 250 to perform certain operations. The deployable component generation application 250 may be provided by the deployable component generation system 300.

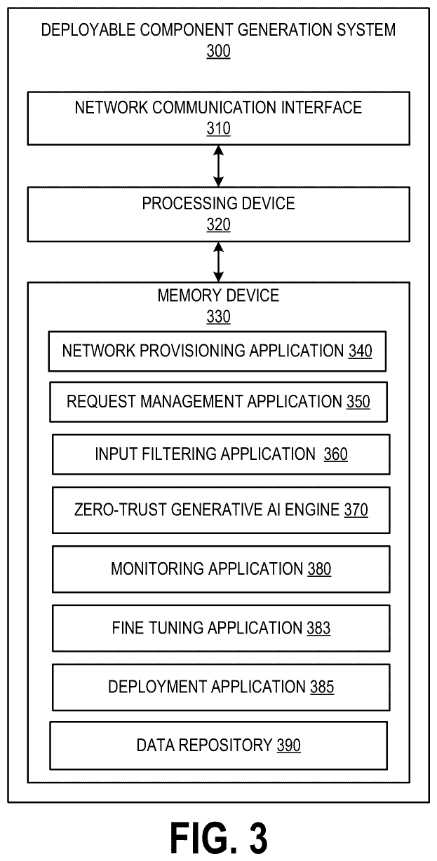

FIG. 3 provides a block diagram illustrating the deployable component generation system 300 in greater detail, in accordance with embodiments of the invention. As illustrated in FIG. 3, in one embodiment of the invention, the deployable component generation system 300 includes one or more processing devices 320 operatively coupled to a network communication interface 310 and a memory device 330. In certain embodiments, the deployable component generation system 300 is operated by an entity, such as a financial institution, while in other embodiments, the deployable component generation system 300 is operated by an entity other than a financial institution. In some embodiments, the deployable component generation system 300 is owned or operated by the entity of the entity system 200. In some embodiments, the deployable component generation system 300 may be an independent system. In alternate embodiments, the deployable component generation system 300 may be a part of the entity system 200.

It should be understood that the memory device 330 may include one or more databases or other data structures/repositories. The memory device 330 also includes computer-executable program code that instructs the processing device 320 to operate the network communication interface 310 to perform certain communication functions of the deployable component generation system 300 described herein. For example, in one embodiment of the deployable component generation system 300, the memory device 330 includes, but is not limited to, a network provisioning application 340, a request management application 350, an input filtering application 360, a zero-trust generative AI engine 370, a monitoring application 380, a fine tuning application 383, a deployment application 385, and a data repository 390 comprising data processed or accessed by one or more applications in the memory device 330. The computer-executable program code of the network provisioning application 340, the request management application 350, the input filtering application 360, the zero-trust generative AI engine 370, the monitoring application 380, the fine tuning application 383, and the deployment application 385 may instruct the processing device 320 to perform certain logic, data-processing, and data-storing functions of the deployable component generation system 300 described herein, as well as communication functions of the deployable component generation system 300.

The network provisioning application 340, the request management application 350, the input filtering application 360, the zero-trust generative AI engine 370, the monitoring application 380, the fine tuning application 383, and the deployment application 385 are configured to invoke or use the data in the data repository 390 when communicating through the network communication interface 310 with the entity system 200, and the computing device system 400. In some embodiments, the network provisioning application 340, the request management application 350, the input filtering application 360, the zero-trust generative AI engine 370, the monitoring application 380, the fine tuning application 383, and the deployment application 385 may store the data extracted or received from the entity system 200 and the computing device system 400 in the data repository 390. In some embodiments, the network provisioning application 340, the request management application 350, the input filtering application 360, the zero-trust generative AI engine 370, the monitoring application 380, the fine tuning application 383, and the deployment application 385 may be a part of a single application. One or more processes performed by the network provisioning application 340, the request management application 350, the input filtering application 360, the zero-trust generative AI engine 370, the monitoring application 380, the fine tuning application 383, and the deployment application 385 are described in detail below.

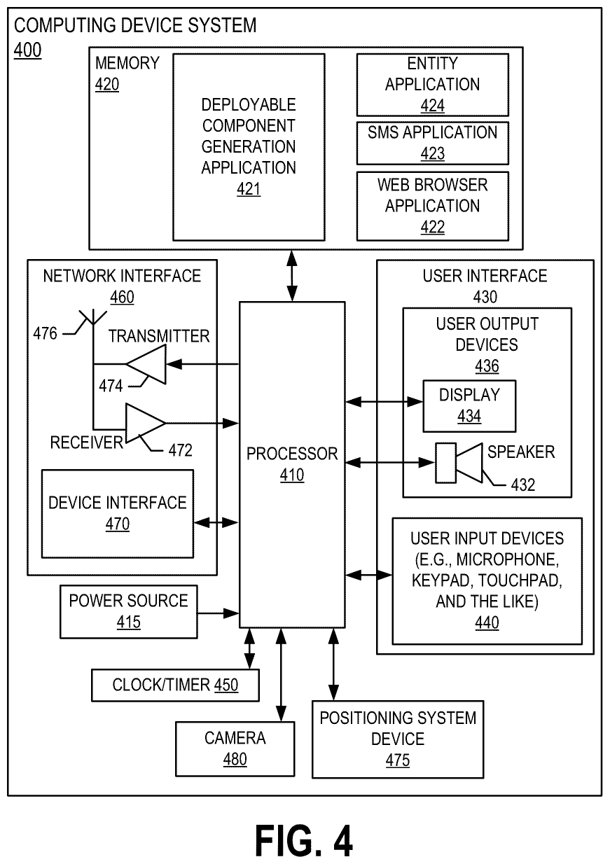

FIG. 4 provides a block diagram illustrating a computing device system 400 of FIG. 1 in more detail, in accordance with embodiments of the invention. However, it should be understood that the computing device system 400 is merely illustrative of one type of computing device system that may benefit from, employ, or otherwise be involved with embodiments of the present invention and, therefore, should not be taken to limit the scope of embodiments of the present invention. The computing devices may include any one of portable digital assistants (PDAs), pagers, mobile televisions, mobile phone, entertainment devices, desktop computers, workstations, laptop computers, cameras, video recorders, audio/video player, radio, GPS devices, wearable devices, Internet-of-things devices, augmented reality devices, virtual reality devices, automated teller machine devices, electronic kiosk devices, or any combination of the aforementioned.

Some embodiments of the computing device system 400 include a processor 410 communicably coupled to such devices as a memory 420, user output devices 436, user input devices 440, a network interface 460, a power source 415, a clock or other timer 450, a camera 480, and a positioning system device 475. The processor 410, and other processors described herein, generally include circuitry for implementing communication and/or logic functions of the computing device system 400. For example, the processor 410 may include a digital signal processor device, a microprocessor device, and various analog to digital converters, digital to analog converters, and/or other support circuits. Control and signal processing functions of the computing device system 400 are allocated between these devices according to their respective capabilities. The processor 410 thus may also include the functionality to encode and interleave messages and data prior to modulation and transmission. The processor 410 can additionally include an internal data modem. Further, the processor 410 may include functionality to operate one or more software programs, which may be stored in the memory 420. For example, the processor 410 may be capable of operating a connectivity program, such as a web browser application 422. The web browser application 422 may then allow the computing device system 400 to transmit and receive web content, such as, for example, location-based content and/or other web page content, according to a Wireless Application Protocol (WAP), Hypertext Transfer Protocol (HTTP), and/or the like.

The processor 410 is configured to use the network interface 460 to communicate with one or more other devices on the network 150. In this regard, the network interface 460 includes an antenna 476 operatively coupled to a transmitter 474 and a receiver 472 (together a “transceiver”). The processor 410 is configured to provide signals to and receive signals from the transmitter 474 and receiver 472, respectively. The signals may include signaling information in accordance with the air interface standard of the applicable cellular system of the wireless network 150. In this regard, the computing device system 400 may be configured to operate with one or more air interface standards, communication protocols, modulation types, and access types. By way of illustration, the computing device system 400 may be configured to operate in accordance with any of a number of first, second, third, and/or fourth-generation communication protocols and/or the like. For example, the computing device system 400 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, with LTE protocols, with 4GPP protocols and/or the like. The computing device system 400 may also be configured to operate in accordance with non-cellular communication mechanisms, such as via a wireless local area network (WLAN) or other communication/data networks.

As described above, the computing device system 400 has a user interface that is, like other user interfaces described herein, made up of user output devices 436 and/or user input devices 440. The user output devices 436 include a display 430 (e.g., a liquid crystal display or the like) and a speaker 432 or other audio device, which are operatively coupled to the processor 410.

The user input devices 440, which allow the computing device system 400 to receive data from a user such as the user 110 may include any of a number of devices allowing the computing device system 400 to receive data from the user 110, such as a keypad, keyboard, touch-screen, touchpad, microphone, mouse, joystick, other pointer device, button, soft key, and/or other input device(s). The user interface may also include a camera 480, such as a digital camera.

The computing device system 400 may also include a positioning system device 475 that is configured to be used by a positioning system to determine a location of the computing device system 400. For example, the positioning system device 475 may include a GPS transceiver. In some embodiments, the positioning system device 475 is at least partially made up of the antenna 476, transmitter 474, and receiver 472 described above. For example, in one embodiment, triangulation of cellular signals may be used to identify the approximate or exact geographical location of the computing device system 400. In other embodiments, the positioning system device 475 includes a proximity sensor or transmitter, such as an RFID tag, that can sense or be sensed by devices known to be located proximate a merchant or other location to determine that the computing device system 400 is located proximate these known devices.

The computing device system 400 further includes a power source 415, such as a battery, for powering various circuits and other devices that are used to operate the computing device system 400. Embodiments of the computing device system 400 may also include a clock or other timer 450 configured to determine and, in some cases, communicate actual or relative time to the processor 410 or one or more other devices.

The computing device system 400 also includes a memory 420 operatively coupled to the processor 410. As used herein, memory includes any computer readable medium (as defined herein below) configured to store data, code, or other information. The memory 420 may include volatile memory, such as volatile Random Access Memory (RAM) including a cache area for the temporary storage of data. The memory 420 may also include non-volatile memory, which can be embedded and/or may be removable. The non-volatile memory can additionally or alternatively include an electrically erasable programmable read-only memory (EEPROM), flash memory or the like.

The memory 420 can store any of a number of applications which comprise computer-executable instructions/code executed by the processor 410 to implement the functions of the computing device system 400 and/or one or more of the process/method steps described herein. For example, the memory 420 may include such applications as a conventional web browser application 422, a deployable component generation application 421, an entity application 424, or the like. These applications also typically instructions to a graphical user interface (GUI) on the display 430 that allows the user 110 to interact with the entity system 200, the deployable component generation system 300, and/or other devices or systems. The memory 420 of the computing device system 400 may comprise a Short Message Service (SMS) application 423 configured to send, receive, and store data, information, communications, alerts, and the like via the wireless network 150.

The memory 420 can also store any of a number of pieces of information, and data, used by the computing device system 400 and the applications and devices that make up the computing device system 400 or are in communication with the computing device system 400 to implement the functions of the computing device system 400 and/or the other systems described herein.

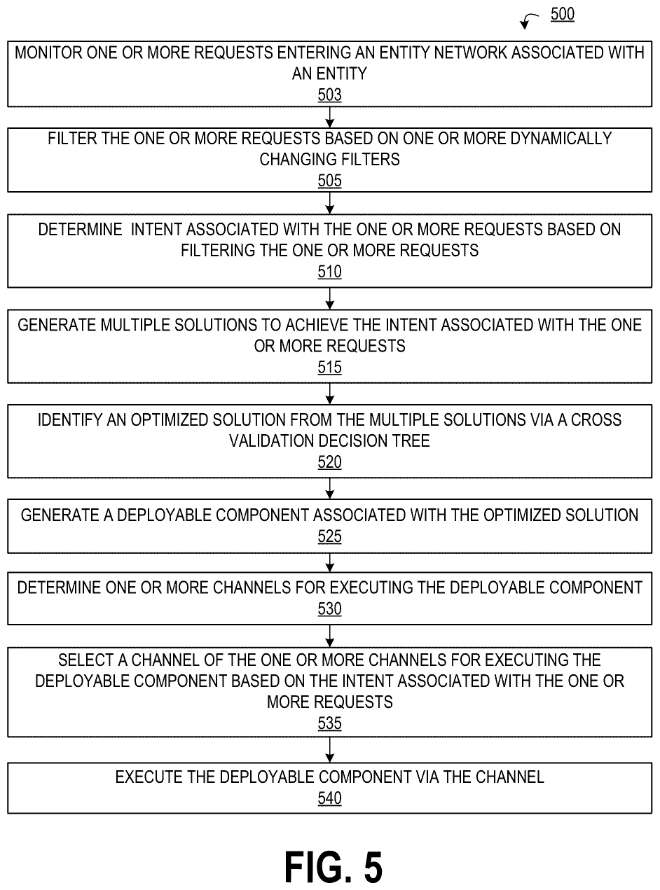

FIG. 5 provides a process flow for generating deployable components associated with software applications for incoming requests via an adaptive zero-trust generative artificial intelligence engine, in accordance with an embodiment of the invention. The system of the present invention may provide the functionalities described herein as a service, where the service can be installed in any of entity systems (e.g., entity system 200) associated with an entity (where examples of entity system may include, but are not limited to, computing systems, networks, servers, databases, or the like) and the service (e.g., deployable component generation application 250) may adapt to the entity system to generate one deployable components for incoming requests via the adaptive zero-trust generative artificial intelligence engine.

As shown in block 503, the system monitors one or more requests entering an entity network associated with an entity. The one or more requests may be associated with transfer of data, insertion, deletion, and/or modification of data, adding, deleting, and/or modifying functionalities associated entity applications, security related requests, and/or the like. In some embodiments, the one or more requests may be initiated by internal systems that are part of the entity. In some embodiments, one or more requests may be initiated by external parties. In some such embodiments, such external parties may unknown parties, parties associated with malicious activity, and/or the like.

As shown in block 505, the system filters the one or more requests based on one or more dynamically changing filters. Filtering the one or more requests may comprise categorizing the one or more requests based on the dynamically changing filters. In some embodiments, the dynamically changing filters may be generated by the system initially based on source associated with initiation of the one or more requests, historical request processing data, application related data, process related data associated with the entity systems/applications (e.g., how data flows internally, process associated with operations of the entity systems/applications), and/or the like.

As shown in block 510, the system determines intent associated with the one or more requests based on filtering the one or more requests. Intent associated with the one or more requests may be purpose, target, or end goal of the one or more requests. For example, the intent associated with a request may be modification to a functionality of an application developed twenty years ago.

As shown in block 515, the system generates multiple solutions to achieve the intent associated with the one or more requests. The system may employ zero-trust generative artificial intelligence engine to generate multiple solutions. In some embodiments, the zero-trust generative artificial intelligence engine may comprise one or more Large Language Models (LLMs), where LLMs are trained on vast amounts of data to generate outputs which may be modified by the engine to suit needs of the application using the zero-trust generative artificial intelligence engine. Continuing with the previous example where the requests is associated with modification of a functionality of the application, the system may generate five solutions to perform the modification. It should be understood that the examples provided herein are for explanatory purposes only and the system may generate ‘n’ number of solutions that are complex in nature. In some embodiments, the zero-trust generative artificial intelligence engine may execute each of the solutions in an isolated environment to detect any exposures associated with fulfilling the one or more requests. In some embodiments, the zero-trust generative artificial intelligence engine detects deceptive requests (e.g., adversarial requests to misguide AI, requests that result in data breach. data poisoning, misuse of AI, and/or the like) via the zero-trust mechanism and provides instantaneous solutions to mitigate the exposure associated with deceptive intent of the requests. In some embodiments, the zero-trust generative artificial intelligence engine may be trained using historical request fulfillment data, training data, and/or the like.

As shown in block 520, the system identifies an optimized solution from the multiple solutions via a cross validation decision tree. The system may perform impact analysis using cross validation decision tree to determine the optimized solution. The system may provide cross validation on the optimized solution determined by the system to reduce variance of performance estimates. Continuing with the previous example, the system may perform impact analysis by predicting the outcome of the five solutions and may select the solution that has a most favorable outcome.

As shown in block 525, the system generates a deployable component associated with the optimized solution. The deployable component may be an executable component, whereupon execution, the deployable component generates a result fulfilling the one or more requests. In some embodiments, the deployable component may comprise at least a software code.

As shown in block 530, the system determines one or more channels for executing the deployable component. Selection of the one or more channels may be based on mode of execution, deployable frequency, style of code, and/or the like. For example, system may determine that an automated mode of execution is the best route for executing the deployable component. In another example, the system may determine that manual execution channel is the best route for executing the deployable component.

As shown in block 535, the system selects a channel of the one or more channels for executing the deployable component based on the intent associated with the one or more requests. The selection of the channel may associated with process or application related to the one or more requests. For example, the system may select an automated channel for the modification request of the application discussed in the previous example based on channel preferences of the application. As shown in block 540, the system executes the deployable component via the channel.

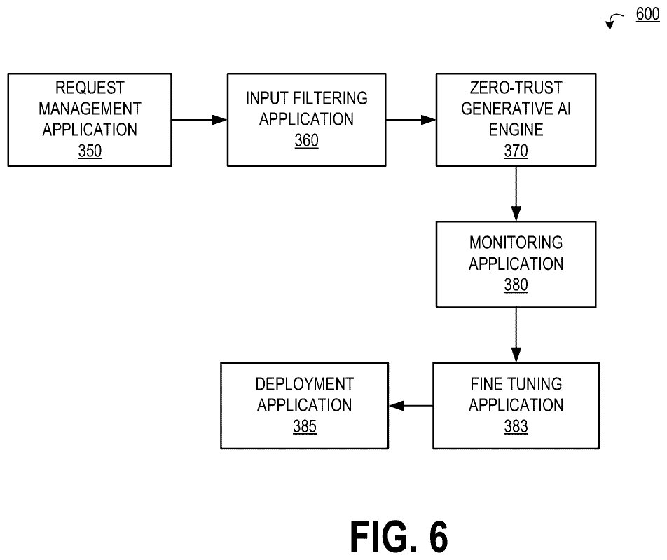

FIG. 6 provides a block diagram illustrating the process of generating deployable components associated with software applications for incoming requests via an adaptive zero-trust generative artificial intelligence engine, in accordance with an embodiment of the invention. As shown, the request management application 350 monitors the entity network for any incoming requests. Upon identification of a request, the request managed application 350 passes information associated with the request to the input filtering application 360 based on the dynamically changing filters and the information in the request. In some embodiments, the dynamically changing filters may be updated dynamically based on outcomes associated with the solutions provided by the system. The zero-trust generative AI engine 370 generates an optimized solution for addressing the request based on filtering of the request, where the optimized solution is packaged as deployable component. The monitoring application 380 may monitor testing of the deployable component and based on monitoring results, the fine tuning application 383 may perform minor modifications to the deployable component which is then deployed or executed via the deployment application 385. In some embodiments, the system may maintain a reinforcement learning and decision database, where the solutions generated and/or executed by the system may be stored using a graphical structure. The components of the system described herein will continuously learn and deploy continuously to instantaneously provide solutions to requests in the form of deployable components.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A system for generating deployable components associated with software applications for incoming requests via an adaptive zero-trust generative artificial intelligence engine, comprising:
at least one processing device;
at least one memory device; and
a module stored in the at least one memory device comprising executable instructions that when executed by the at least one processing device, cause the at least one processing device to:
monitor one or more requests entering an entity network associated with an entity;
filter the one or more requests based on one or more dynamically changing filters;
determine intent associated with the one or more requests based on filtering the one or more requests;
generate multiple solutions to achieve the intent associated with the one or more requests;
identify an optimized solution from the multiple solutions via a cross validation decision tree;
generate a deployable component associated with the optimized solution; and
execute the deployable component via a channel.

2. The system according to claim 1, wherein the executable instructions cause the at least one processing device to:
determine one or more channels for executing the deployable component; and
select the channel of the one or more channels for executing the deployable component based on the intent associated with the one or more requests.

3. The system according to claim 1, wherein filtering the one or more requests comprises categorizing the one or more requests based on the one or more dynamically changing filters.

4. The system according to claim 1, wherein the executable instructions cause the at least one processing device to generate the dynamically changing filters based on historical request processing data.

5. The system according to claim 4, wherein the executable instructions cause the at least one processing device to update the dynamically changing filters based on outcomes associated with executing the deployable component.

6. The system according to claim 1, wherein the executable instructions cause the at least one processing device to identify the optimized solution from the multiple solutions via the cross validation decision tree based on performing impact analysis on the multiple solutions.

7. The system according to claim 1, wherein the executable instructions cause the at least one processing device to:
generate a unique identifier for the one or more requests; and
link the unique identifier to the one or more requests to allow tracking processing associated with the one or more requests.

8. A computer program product for generating deployable components associated with software applications for incoming requests via an adaptive zero-trust generative artificial intelligence engine, comprising a non-transitory computer-readable storage medium having computer-executable instructions for:
monitoring one or more requests entering an entity network associated with an entity;
filtering the one or more requests based on one or more dynamically changing filters;
determining intent associated with the one or more requests based on filtering the one or more requests;
generating multiple solutions to achieve the intent associated with the one or more requests;
identifying an optimized solution from the multiple solutions via a cross validation decision tree;
generating a deployable component associated with the optimized solution; and
executing the deployable component via a channel.

9. The computer program product according to claim 8, wherein the non-transitory computer-readable storage medium comprises computer-executable instructions for:
determining one or more channels for executing the deployable component; and
selecting the channel of the one or more channels for executing the deployable component based on the intent associated with the one or more requests.

10. The computer program product according to claim 8, wherein filtering the one or more requests comprises categorizing the one or more requests based on the one or more dynamically changing filters.

11. The computer program product according to claim 8, wherein the non-transitory computer-readable storage medium comprises computer-executable instructions for generating the dynamically changing filters based on historical request processing data.

12. The computer program product according to claim 11, wherein the non-transitory computer-readable storage medium comprises computer-executable instructions for updating the dynamically changing filters based on outcomes associated with executing the deployable component.

13. The computer program product according to claim 8, wherein the non-transitory computer-readable storage medium comprises computer-executable instructions for identifying the optimized solution from the multiple solutions via the cross validation decision tree based on performing impact analysis on the multiple solutions.

14. The computer program product according to claim 8, wherein the non-transitory computer-readable storage medium comprises computer-executable instructions for:
generating a unique identifier for the one or more requests; and
linking the unique identifier to the one or more requests to allow tracking processing associated with the one or more requests.

15. A computerized method for generating deployable components associated with software applications for incoming requests via an adaptive zero-trust generative artificial intelligence engine, the method comprising:
monitoring one or more requests entering an entity network associated with an entity;
filtering the one or more requests based on one or more dynamically changing filters;
determining intent associated with the one or more requests based on filtering the one or more requests;
generating multiple solutions to achieve the intent associated with the one or more requests;
identifying an optimized solution from the multiple solutions via a cross validation decision tree;
generating a deployable component associated with the optimized solution; and
executing the deployable component via a channel.

16. The computerized method according to claim 15, wherein the method comprises
determining one or more channels for executing the deployable component; and
selecting the channel of the one or more channels for executing the deployable component based on the intent associated with the one or more requests.

17. The computerized method according to claim 15, wherein filtering the one or more requests comprises categorizing the one or more requests based on the one or more dynamically changing filters.

18. The computerized method according to claim 15, wherein the method comprises generating the dynamically changing filters based on historical request processing data.

19. The computerized method according to claim 18, wherein the method comprises updating the dynamically changing filters based on outcomes associated with executing the deployable component.

20. The computerized method according to claim 15, wherein the method comprises identifying the optimized solution from the multiple solutions via the cross validation decision tree based on performing impact analysis on the multiple solutions.
